(19) United States
(12) Patent Application Publication
(10) Pub. No.: US 2016/0247132 A1
(43) Pub. Date: Aug. 25, 2016

(54) AFFILIATED INDIVIDUAL IDENTIFICATION AND ACCOUNT RECOUPMENT

(71) Applicant: EBAY INC., SAN JOSE, CA (US)

(72) Inventor: Kamal Zamer, Austin, TX (US)

(21) Appl. No.: 14/631,470

(22) Filed: Feb. 25, 2015

(51) Int. Cl. G06Q 20/14; G06Q 30/04

(52) U.S. Cl. CPC G06Q 20/14; G06Q 30/04; G06Q 50/01

(57) ABSTRACT

A method including identifying a delinquent account from multiple accounts managed by a financial services institution. The delinquent account is held by an account holder. The method includes accessing data pertaining to social networking activity of the account holder. The method includes reviewing the data pertaining to social network activity to identify an individual who is affiliated with the account holder. The method includes transmitting to a social media account of the affiliated individual, a payment solicitation that requests the affiliated individual make a payment to the delinquent account on behalf of the account holder. The method includes receiving a payment message that authorizes a payment to the delinquent account. The method includes applying the payment to the delinquent account.

### FIELD

The embodiments discussed herein are related to affiliated individual identification and account recoupment.

### BACKGROUND

In some circumstances, an account holder of a financial account may allow the financial account to become delinquent. For example, the account holder may stop making monthly payments to the financial account. In these and other circumstances, a financial services institution that manages the financial account may attempt to collect or recoup outstanding amounts from the account holder and/or an individual affiliated with the account holder. Manual account recoupment may be difficult and costly.

The subject matter claimed herein is not limited to embodiments that solve any disadvantages or that operate only in environments such as those described above. Rather, this background is only provided to illustrate one example technology area where some embodiments described herein may be practiced.

### BRIEF DESCRIPTION OF THE DRAWINGS

Example embodiments will be described and explained with additional specificity and detail through the use of the accompanying drawings in which:

FIG. 1 illustrates an example operating environment in which account recoupment may be implemented;

FIG. 2 illustrates an example of affiliated individual identification that may be implemented in the operating environment of FIG. 1;

FIG. 3 illustrates an example of account recoupment process that may be implemented in the operating environment of FIG. 1;

FIG. 4 illustrates an example computing system configured for account recoupment;

FIG. 5 is a flowchart of an example method of account recoupment; and

FIG. 6 is a flowchart of another example method of account recoupment.

### DESCRIPTION OF EMBODIMENTS

Some embodiments described herein relate to affiliated individual identification and account recoupment. Generally, in some embodiments, one or more individuals are identified from affiliations between the individuals and an account holder. The individuals identified as being affiliated with the account holder may be referred to as affiliated individuals in the present disclosure. After the affiliated individuals are identified, they are asked whether they are willing to make a payment to a delinquent account of the account holder. The payment may be applied to the delinquent account. Thus, the affiliated individuals may make payments to the delinquent account on behalf of the account holder.

The affiliated individuals may be identified from a myriad of interactions between the affiliated individuals and the account holder. For example, interactions via social media, financial transactions, contact lists in an account holder device that is associated with the account holder, similar location patterns between the affiliated individual and the account holder, or some combination thereof may be used to identify the affiliated individuals. The interactions may be identified using application program interface (API) calls, a web crawler, or any other applicable data surveying or requesting operation.

In an example embodiment, a method includes identifying a delinquent account from multiple accounts managed by a financial services institution. The delinquent account is held by an account holder. The method includes accessing data pertaining to social networking activity of the account holder and reviewing the data pertaining to social network activity to identify an individual who is affiliated with the account holder. The method includes transmitting, to a social media account of the affiliated individual, a payment solicitation that requests the affiliated individual make a payment to the delinquent account on behalf of the account holder. The method includes receiving a payment message that authorizes a payment to the delinquent account and applying the payment to the delinquent account.

In another example embodiment, a method includes accessing a social media account of an account holder of a financial account. The method includes scanning the social media account of the account holder for social media activity illustrative of an affiliation between an individual and the account holder. In response to the account becoming delinquent, the method includes communicating a solicitation message to an affiliated individual. The solicitation message may request the affiliated individual to make a payment to the financial account of the account holder. The method includes receiving a payment message that authorizes a payment from a financial account of the affiliated individual to the financial account of the account holder. In response to reception of the payment message, the method includes applying the payment to the delinquent account.

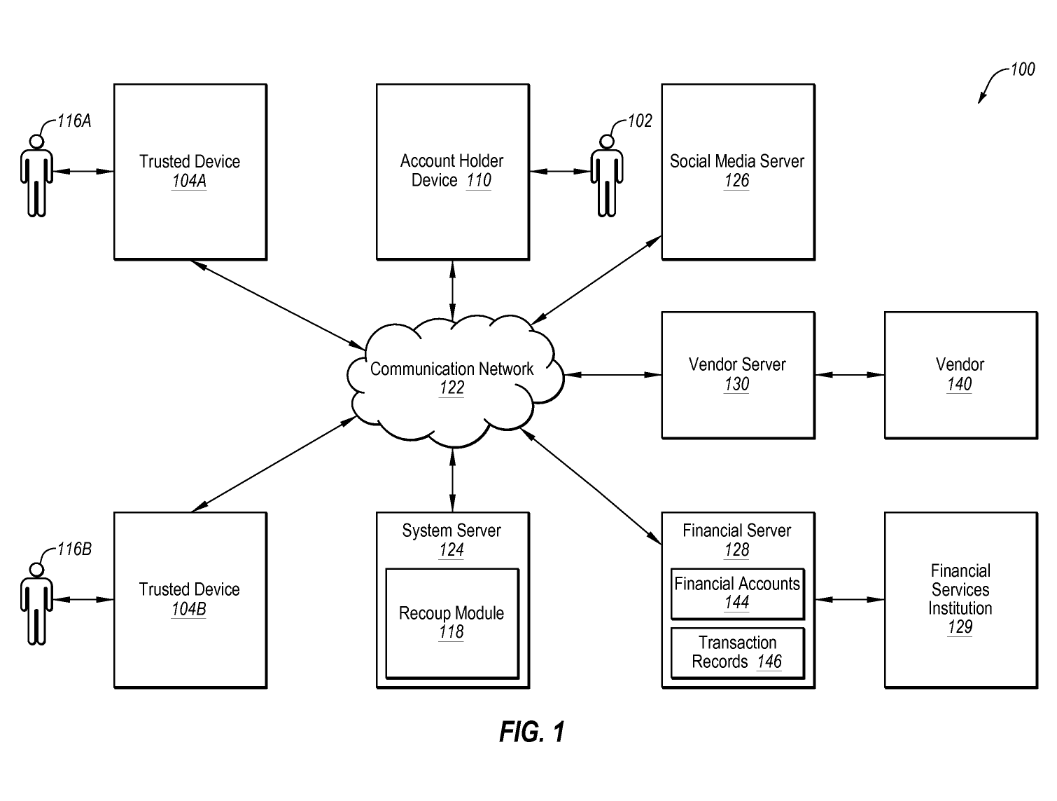

Turning to the figures, FIG. 1 illustrates an example operating environment 100 in which account recoupment may be implemented, according to at least one embodiment. In the operating environment 100, an account holder 102 may hold one of multiple financial accounts 144, which may be managed by a financial services institution 129. A system server 124 may support and perform automated or semi-automated recoupment of outstanding or delinquent payments to the financial account 144 of the account holder 102.

For instance, a recoup module 118 may identify one or more individuals 116A and 116B (generally, individual 116 or individuals 116) who may have an affiliation with the account holder 102. Instead of, or in addition to recoupment efforts directed at the account holder 102, the recoup module 118 may communicate a solicitation message to the individuals 116 identified as having an affiliation with the account holder 102. The solicitation message may request that the individuals 116 make a payment to the financial account 144 of the account holder 102 on behalf of the account holder 102.

The operating environment 100 of FIG. 1 may include trusted devices 104A and 104B (generally, trusted device 104 or trusted devices 104), an account holder device 110, a social media server 126, a vendor server 130, a financial server 128, the system server 124, and a communication network 122. The trusted devices 104, the account holder device 110, the system server 124, the social media server 126, the vendor server 130, and the financial server 128 (collectively, environment components) may communicate information and data via the communication network 122. For example, one or more of the environment components may communicate information and data related to account recoupment. The environment components are briefly described in the following paragraphs.

The communication network 122 may include a wired network, a wireless network, or a combination thereof. The communication network 122 may include any suitable configuration or configurations including a star configuration, token ring configuration, or other configurations. The communication network 122 may include a local area network (LAN), a wide area network (WAN) (e.g., the Internet), and/or other interconnected data paths across which multiple devices may communicate. In some embodiments, the communication network 122 may include a peer-to-peer network. The communication network 122 may also be coupled to or include portions of a telecommunications network that may enable communication of data in a variety of different communication protocols. In some embodiments, the communication network 122 includes BLUETOOTH® communication networks and/or cellular communication networks for sending and receiving data including via short messaging service (SMS), multimedia messaging service (MMS), hypertext transfer protocol (HTTP), direct data connection, wireless application protocol (WAP), e-mail, and the like.

The vendor server 130 may include a hardware server that includes a processor, memory, and network communication capabilities. The vendor server 130 may be configured for communication with one or more other environment components via the communication network 122.

The vendor 140 may include any entity that may be engaged in some economic activity such as offering for sale goods or services. In some embodiments, the vendor 140 may include a merchant, a landlord, a service-providing entity, etc. The vendor server 130 may be associated with a vendor 140. For example, an association between the vendor server 130 and the vendor 140 may include enabling or facilitating economic activities of the vendor 140 via the vendor server 130, storage of records of financial transactions of the vendor 140 at the vendor server 130, enabling access to records of financial transactions of the vendor 140 via the vendor server 130, hosting by the vendor server 130 a website of the vendor 140, general ownership or operation of the vendor server 130 by the vendor 140, and communicating information and data by the vendor 140 via the vendor server 130 to and from other environment components.

In some embodiments, the account holder 102 and the individuals 116 may execute a financial transaction with the vendor 140. The financial transactions may be executed via the vendor server 130 in some instances. Additionally, a record of the financial transaction with the vendor 140 may be stored on or accessed via the vendor server 130. The record of the financial transition may include, for example, a credit card used in the transaction, a link from which the account holder 102 or the individuals 116 are directed to the vendor server 130, a network address of the account holder 102 or the individual 116, and other information related to the financial transaction.

The financial server 128 may include a hardware server that includes a processor, memory, and network communication capabilities. The financial server 128 may be configured for communication with one or more other environment components via the communication network 122.

The financial server 128 may enable and/or facilitate financial transactions by the account holder 102 and the individuals 116. The financial transactions may be executed with the vendor 140 and between the account holder 102 and the individuals 116. The financial server 128 may include information related to the financial accounts 144, which may be managed by the financial services institution 129. One or more of the financial accounts 144 may be held by the account holder 102, the individuals 116, and the vendor 140. In some embodiments, the financial server 128 may enable transfers of funds between the financial accounts 144 or to accounts managed by other institutions (e.g., banks) that may be held by the account holder 102, the individuals 116, and/or the vendor 140. For example, to purchase a good from the vendor 140, the account holder 102 may transfer funds from one of the financial accounts 144 held by the account holder 102 to another of the financial accounts 144 held by the vendor 140. Similarly, to pay a first individual 116A, the account holder 102 may transfer funds from one of the financial accounts 144 held by the account holder 102 to another of the financial accounts 144 held by the first individual 116A.

The financial server 128 may include transaction records 146. The transaction records 146 may record information related to financial transactions. For example, the record information may include parties (e.g., the vendor 140, the account holder 102, the individuals 116) involved in a transaction, a date of a transaction, an amount of funds transferred in a transaction, the financial accounts 144 involved in a transaction, other accounts linked to the financial accounts 144 involved in a transaction, credit cards used, transaction date, other transaction details, or some combination thereof. In some embodiments the transaction records 146 or some subset of the information contained therein may be accessed via the financial server 128.

The social media server 126 may include a hardware server that includes a processor, memory, and network communication capabilities. In the illustrated implementation, the social media server 126 is configured to communicate via the communication network 122 with the other environment components.

The social media server 126 may be configured to support a social network. The social network may include a social structure in which the account holder 102, the individuals 116, the vendor 140, the financial services institution 129 and/or multiple other entities may be connected by a common feature. The common feature may include relationships or connections such as friendship, family, work, an interest, and the like. The common features may be provided by the social media server 126. For example, the social media server 126 may be configured to provide explicitly defined relationships and relationships implied by social connections between online users. The relationships and/or the common features may form a social graph in the social network. In some examples, the social graph may reflect a mapping of the online users and how they may be related.

The social network may enable or provide interfaces that enable various social network activities. For example, the social network may provide a data feed for one or more users (e.g., the account holder 102 and/or the individuals 116) of the social network in which one or more of the users may post messages or media, the social network may enable individuals to be tagged in photographs and videos posted on the social network, and the social network may provide an invitation interface in which the users may collectively or individually invite other users to calendar events and receive RSVPs to the calendar events.

In addition, the social network may provide payment features that may enable the users to submit payments via the social network. In some embodiments, the social media server 126 may interface with the financial server 128 and/or the vendor server 130 to enable execution of financial transactions from the social network.

The social media server 126 may be responsive to data requests such as application programming interface (API) calls. The data requests may request data related to one of the users and the social network activities associated with the corresponding user.

The trusted devices 104 and the account holder device 110 may include computing devices that may include a processor, memory, and network communication capabilities. The trusted devices 104 and the account holder device 110 may be configured for communication with one or more other environment components via the communication network 122. Some examples of the trusted devices 104 and the account holder device 110 include a laptop computer, a desktop computer, a tablet computer, a mobile telephone, a smartphone, a personal digital assistant (“PDA”), a mobile e-mail device, a portable game player, a portable music player, smart wearable technology, or any other applicable electronic device capable of accessing the communication network 122.

The trusted devices 104 may be associated with one or more of the individuals 116. An association between the trusted devices 104 and the individuals 116 may include ownership or regular operation of the trusted devices 104 by the individuals 116. For example, a message communicated to the trusted device 104 may be intended for one of the individuals 116.

Similar to the association of the trusted devices 104 with respect to the individuals 116, the account holder device 110 may be associated with the account holder 102. An association between the account holder device 110 and the account holder 102 may include ownership or regular operation of the account holder device 110 by the account holder 102. For example, a message communicated to the account holder device 110 may be intended for the account holder 102.

The system server 124 may include a hardware server that includes a processor, memory, and network communication capabilities. In the illustrated implementation, the system server 124 is configured to communicate via the communication network 122 with the other environment components.

The system server 124 may include the recoup module 118. The recoup module 118 may include code and routines for account recoupment. Additionally or alternatively, the recoup module 118 may be implemented using hardware including a processor, a microprocessor (e.g., to perform or control performance of one or more operations), a FPGA, or an ASIC. In some other instances, the recoup module 118 may be implemented using a combination of hardware and software.

The individuals 116 that are associated with the trusted devices 104 may be affiliated with the account holder 102. As used herein an affiliation between the individuals 116 and the account holder 102 may include a financial affiliation, a geographic affiliation, an employee/employer affiliation, a familial affiliation, a friendship, and the like. Because the affiliation between the individuals 116 and the account holder 102, the individuals 116 may be more likely to make a payment to the financial account 144 held by the account holder 102. For example, the individuals 116 with a familial affiliation with the account holder 102 may make a payment to a delinquent account of the account holder 102 on behalf of the account holder 102.

In some embodiments, the recoup module 118 may identify multiple individuals 116 who are affiliated with the account holder 102. Solicitation messages may be communicated to each or both of the individuals 116. The recoup module 118 may start by sending a solicitation message to one of the individuals 116 having a particular type of affiliation with the account holder 102 and may later send a solicitation message to another of the individuals 116 having a second particular type of affiliation. For example, the first individual 116A may be a family member and a second individual 116B may include a friend. The recoup module 118 may first communicate solicitation messages to the first individual 116A. In some embodiments, the recoup module 118 may determine to whom to communicate solicitation messages based on economic factors, historical payments, and the like.

In some embodiments, the recoup module 118 may identify a delinquent account from the financial accounts 144 that is held by the account holder 102. The delinquent account may include a financial account for which the account holder 102 has stopped paying. The recoup module 118 may identify one or more of the individuals 116 that is affiliated with the account holder 102. The recoup module 118 may communicate a solicitation message. The solicitation message that requests the affiliated individual 116 make a payment to the delinquent account on behalf of the account holder 102. The recoup module 118 may receive a payment message. The payment message may authorize a payment to the delinquent account. The recoup module 118 may apply the payment to the delinquent account.

Account recoupment performed by the recoup module 118 may include one or more sub-operations. In some embodiments, account recoupment may include interaction and communication with the social media server 126. For example, the recoup module 118 may access data pertaining to social networking activity of the account holder 102 and/or a social media account from the social media server 126. The recoup module 118 may review the data pertaining to social network activity to identify one or more of the individuals 116 who are affiliated with the account holder 102. Additionally, the recoup module 118 may scan the social media account of the account holder 102 for social media activity illustrative of an affiliation between one or more of the individuals 116 and the account holder 102. The recoup module 118 may transmit a solicitation message to a social media account of the individual 116.

In the depicted embodiment the recoup module 118 is included in the system server 124. In some embodiments, the recoup module 118 and/or one or more of the operations attributed herein to the recoup module 118 may be performed by the account holder device 110, a financial server 128, or a component included therein.

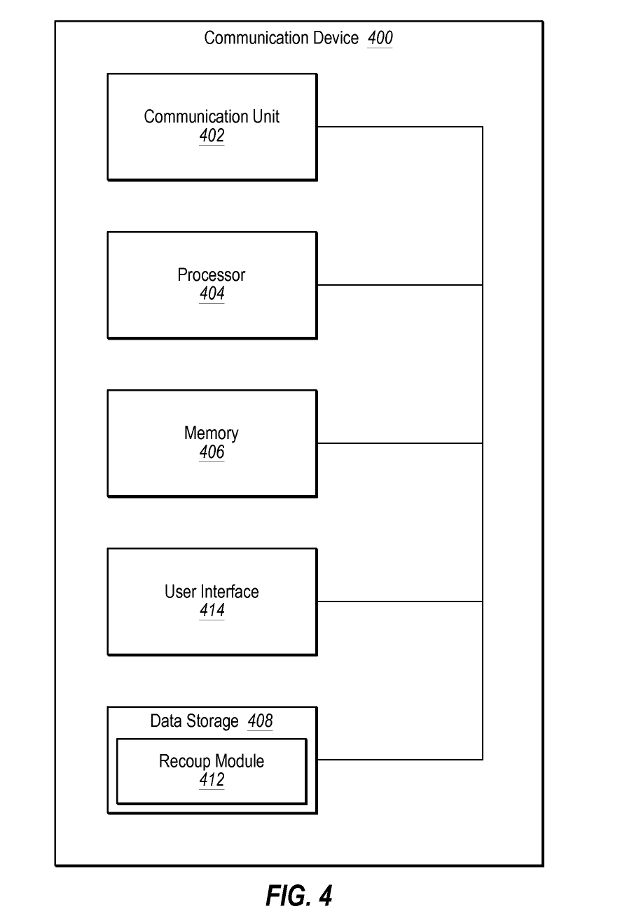

In the operating environment 100, memory in one or more of the environment components may be similar to memory 406 described with reference to FIG. 4, processors in one or more of the environment components may be similar to a processor 404 described with reference to FIG. 4, and network communication capabilities of one or more of the environment components may be provided by a communication unit 402 described with reference to FIG. 4.

Modifications, additions, or omissions may be made to the operating environment 100 without departing from the scope of the present disclosure. Specifically, embodiments depicted in FIG. 1 include two trusted devices 104 associated with two individuals 116, one account holder device 110 associated with one account holder 102, one system server 124, one financial server 128, one vendor server 130, and one social media server 126. The present disclosure may apply to operating environments that may include one or more trusted devices 104 associated with one or more individuals 116, one or more user devices 110 associated with one or more users 102, one or more system servers 124, one or more financial servers 128, one or more vendor servers 130, one or more social media servers 126, or some combination thereof.

Moreover, the separation of various components in the embodiments described herein is not meant to indicate that the separation occurs in all embodiments. It may be understood with the benefit of this disclosure that the described components may be integrated together in a single component or separated into multiple components. For example, in some embodiments the system server 124 and the financial server 128 may be a single server.

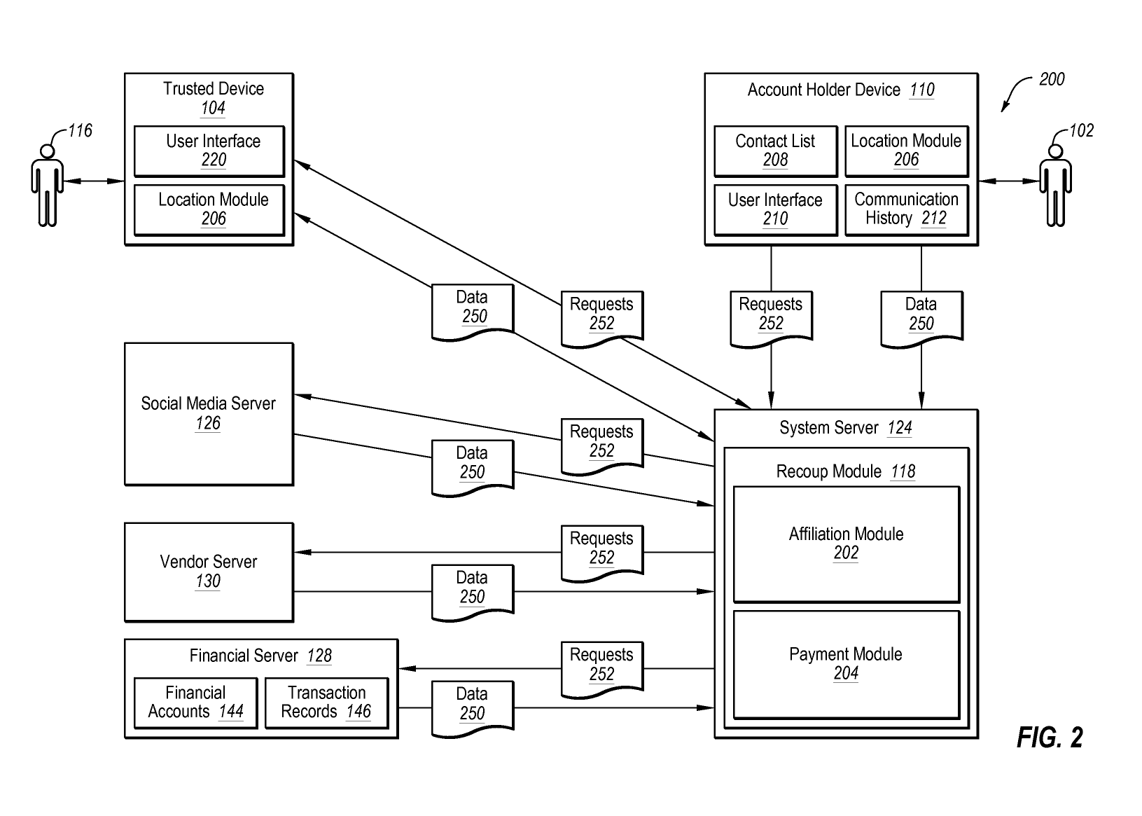

FIG. 2 illustrates an example of affiliated individual identification 200 that may be implemented in the operating environment 100 of FIG. 1. FIG. 2 includes the social media server 126, the vendor server 130, the financial server 128, the account holder device 110, the account holder 102, the individual 116, and the system server 124 of FIG. 1. Although, FIG. 2 illustrates only one individual 116 and one trusted device 104, embodiments of the present disclosure are not limited to one individual 116 and/or one trusted device 104. While the communication network 122 is omitted from FIG. 2, it may be understood with the benefit of this disclosure that communication between the social media server 126, the vendor server 130, the financial server 128, and the trusted device 104, the account holder device 110, and the system server 124 may be via the communication network 122 of FIG. 1.

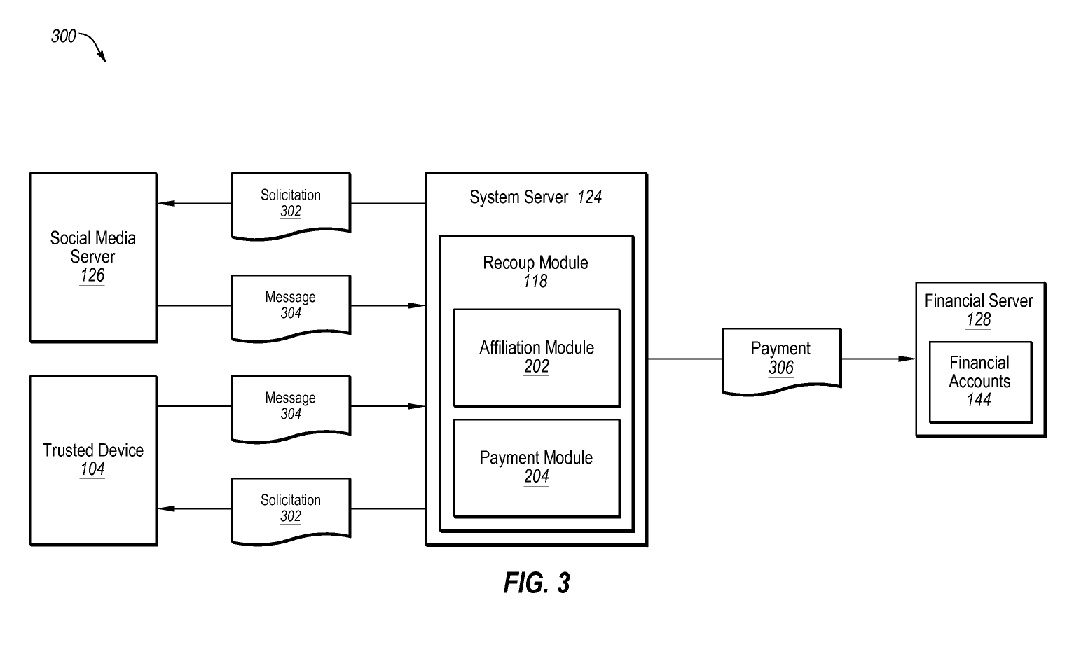

In FIG. 2, the recoup module 118 includes an affiliation module 202 and a payment module 204. The affiliation module 202 may perform one or more operations of the affiliated individual identification. The payment module 204 may perform one or more operations of account recoupment, some details of which are provided with reference to FIG. 3.

Generally, the affiliated individual identification may be based on data 250 that indicates an affiliation between the individual 116 and the account holder 102. Thus, the affiliation module 202 may access and/or request the data 250 and receive the data 250. The affiliation module 202 may further determine, based on the data 250, whether an affiliation exists between the individual 116 and the account holder 102. For example, the affiliation module 202 may include one or more data thresholds, above which an affiliation is deemed to exist.

In the depicted operating environment 100, the affiliated individual identification may be based on data 250 pertaining to social network activity of the account holder 102, financial transactions executed by the individual 116 and executed by the account holder 102 at a common vendor (e.g., the vendor 140 of FIG. 1), a pattern of common device locations, a contact list 208 of the account holder device 110, a request received from the account holder 102, a communication history 212 of the account holder device 110, any other data 250 that may indicate an affiliation between the account holder 102 and the individual 116, or some combination thereof.

Accordingly, the affiliation module 202 may be configured to access and/or request the data 250 indicative of an affiliation between the individual 116 and the account holder 102 from the account holder device 110, the social media server 126, the vendor server 130, the financial server 128, or some combination thereof. In FIG. 2, the access and/or requests are represented by requests 252. Additionally, the affiliation module 202 may be configured to receive the data 250 (e.g., the contact list 208) from the account holder device 110, the social media server 126, the vendor server 130, the financial server 128, or some combination thereof.

In some embodiments, the affiliation module 202 may be configured to generate and communicate the requests 252. The requests may include application programming interface (API) calls. The API calls may include a get subroutine configured to retrieve the data 250. For example, the affiliation module 202 may communicate an API call to the social media server 126. The API call may include a get subroutine that is configured to retrieve data 250 pertaining to social network activity that is illustrative of the affiliation between the account holder 102 and the individual 116. Additionally or alternatively, the affiliation module 202 may employ a web crawler, another data gathering application, or communicate a petition message to access or request the data 250. The data 250 may include a list of information responsive to the request 252. Additionally or alternately, the data 250 may include cookies or a user handle of the account holder 102 or the individual 116.

The affiliation module 202 may identify affiliated individuals based on social media activities. To identify the affiliated individuals based on the social media activities, the affiliation module 202 may first find one or more social media accounts of the account holder 102.

In some embodiments, the affiliation module 202 may read a network address of the account holder 102. The network address may be read from the financial account 144 of the account holder 102 in some embodiments. For example, the network address may be provided by the account holder 102 for communication with the financial services institution 129.

The network address may be used to access a social media account of the account holder 102 hosted or supported by the social media server 126. For instance, the network address may include an email address of the account holder 102. The email address may include a user handle that is used on a social network. Accordingly, the affiliation module 202 may extract the user handle or some variation thereof from the email address and search for a social media account of the account holder 102 based thereon. Additionally, the email address may be used in the social network and the affiliation module 202 may search the social media server 126 for the email address.

Additionally or alternatively, to find the social media account of the account holder 102, the affiliation module 202 may parse data pertaining to executed financial transactions. For example, the affiliation module 202 may access transaction records 146 of the financial server 128 or of the vender server 130. The financial transactions may be draw from the financial account of the account holder 102. From the transaction records 146, the affiliation module 202 may trace a social media account from which an execution financial transaction originated.

For example, a purchase may be made by the account holder 102 at an online retailer such as eBay®. The purchase may have originated at a link posted to a network address or to a social media account. The affiliation module 202 may analyze data 250 pertaining to the purchase such as cookies or a browser history of the account holder device 110 to find the social media account on which the link was posted or the network address to which the link was communicated. The affiliation module 202 may ascertain that the social media account on which the link was posted is the social media account of the account holder 102. Additionally, the affiliation module 202 may ascertain that the network address to which the link was communicated is the network address of the account holder 102. The affiliation module 202 may then search for social media accounts based on the network address or derivatives or variations thereof.

After the affiliation module 202 finds the social media account of the account holder 102, the affiliation module 202 may request the data 250 pertaining to social media activity of the account holder 102 from the social media server 126. The affiliation module 202 may utilize API calls or may access and search a social media account of the account holder 102. The affiliation module 202 may review the data pertaining to social network activity to determine whether there is an affiliation between the individual 116 and the account holder 102.

Some examples of the data 250 pertaining to social network activity may include photographs and videos in which the account holder 102 and the individual 116 are tagged, posts to data feeds of the individual 116 by the account holder 102, posts to a data feed of the individual 116 by the account holder 102, RSVPs to common calendar events by the account holder 102 and the individual 116, and a relationship status (e.g., a friend) of the individual 116 with relation to the account holder 102.

The affiliation module 202 may identify affiliated individuals based on social media activity of the account holder 102. The affiliation module 202 may determine whether an affiliation exists between the individual 116 and the account holder 102 based on a number of photographs or videos in which the account holder 102 and the individual 116 are tagged, a frequency and/or number of posts to a data feed of the individual 116 by the account holder 102, a frequency and/or number of posts to a data feed of the account holder 102 by the individual 116, a frequency and/or number of RSVPs to common calendar events by the account holder 102 and the individual 116, a relationship status of the individual 116 with relation to the account holder 102, or some combination thereof. For example, if the individual 116 has a relationship status as being a friend with the account holder 102 and the individual 116 and the account holder 102 have RSVP'd to a threshold number (e.g., five) events in a particular area, the affiliation module 202 may determine an affiliation exists between the individual 116 and the account holder 102. Moreover, the affiliation module 202 may determine that the type of affiliation is a social friendship with the individual 116 and the account holder 102 socializing in a particular geographic area.

Additionally, the affiliation module 202 may be configured to identify affiliated individuals based on the contact list 208 and/or the communication history 212. For instance, the affiliation module 202 may obtain the contact list 208 and/or the communication history 212 from the account holder device 110. In some embodiments, the affiliation module 202 may request access to the contact list 208 and/or the communication history 212. In some embodiments, the account holder 102 may communicate the contact list 208 and/or the communication history 212 to the system server 124. A presence of the individual 116 in the contact list 208 may be indicative of an affiliation between the account holder 102 and the individual 116.

The communication history 212 may include data 250 pertaining to the communication history 212 that may be indicative of an affiliation between the account holder 102 and the individual 116. For example, the data 250 pertaining to the communication history 212 may include a history of telephone calls, emails, text messages, and media communications between the individual 116 and the account holder 102. A determination of whether an affiliation exists between the individual 116 and the account holder 102 may be based on a number and/or frequency of telephone calls, emails, text messages, and media communications between the individual 116 and the account holder 102.

The affiliation module 202 may be configured to identify affiliated individuals based on the data 250 pertaining to financial transactions. For instance, the affiliation module 202 may access or request the transaction records 146 from the financial server 128 and/or the vendor server 130. The affiliation module 202 may parse the transaction records 146 for transactions between the individual 116 and the account holder 102 and/or transactions involving the individual 116 and a vendor and the account holder 102 and the vendor. Based on the data 250 pertaining to financial transactions, the affiliation module 202 may determine whether an affiliation exists.

Additionally, the affiliation module 202 may be configured to identify affiliated individuals based on device locations and/or patterns of device locations. The device locations may be provided by a location module 206. In FIG. 2, the trusted device 104 and the account holder device 110 include the location module 206. The location module 206 may include a global positioning signal (GPS) receiver or network multilateration capabilities. The location module 206 may communicate a device location to the system server 124 and/or the location module 206 may communicate the device location to the social media server 126. The device location may be posted in a data feed of a social network. The affiliation module 202 may retrieve the location data and create a pattern of device location data based on the device locations. The affiliation module 202 may then determine that an affiliation exists between the account holder 102 and the individual 116 based on commonalities between or overlap of the patterns of device location data. For example, the affiliation module 202 may determine whether an overlap of the device location pattern of the trusted device 104 and the device location pattern of the account holder device 110 is greater than a particular threshold. If the overlap is greater than the particular threshold, the affiliation module 202 may conclude that an affiliation exists.

In some embodiments, the affiliation module 202 may be configured to communicate an API call to the social media server 126. The API call may include a get subroutine that is configured to obtain location data of the trusted device 104 associated with the individual 116 and/or location data of the account holder device 100. The affiliation module 202 may then create the pattern of device location data from the location data obtained from the social media server 126.

Additionally, in some embodiments, the affiliation module 202 may offer an incentive in exchange for identification of an affiliated individual. For instance, during execution of a financial transaction with the financial services institution, the affiliation module 202 may request identification of an affiliated individual from the account holder 102.

The affiliation module 202 may make such affiliated individual identification request in a subset of transactions. For example, the affiliation module 202 may make the affiliated individual identification request when a transaction involves an extension of credit by the financial services institution for execution of the financial transaction and/or a monetary amount above a particular amount (e.g., $5000). Additionally or alternatively, the affiliation module 202 may make the affiliated individual identification request when the account holder 102 has a poor payment history.

After the individual 116 is identified as being affiliated with the account holder 102, the affiliation module 202 may retrieve a network address of the affiliated individual 116. In some embodiments, the network address of the affiliated individual 116 may be retrieved from the social media activity or network address included in a transaction record 146.

The network address of the affiliated individual 116 may be compared to the financial accounts 144 managed by a financial services institution. From the financial accounts 144 one or more other network addresses of the affiliated individual may be read. Accordingly, the affiliation module 202 may determine one or more network addresses to which the payment module 204 may communicate a solicitation message. Additionally, from the one or more network addresses of the individual 116, the affiliation module may access a social media account of the individual 116 hosted or supported on the social media server 126.

In embodiments in which one or more operations attributed herein to the recoup module 118 are performed by the user module 108, messages 254 may be communicated between the trusted device 104 and the user module 108. Additionally, some portion of the data 250 and/or requests 252 may be communicated with the user module 108.

FIG. 3 illustrates an example of account recoupment process 300 that may be implemented in the operating environment 100 of FIG. 1. FIG. 3 includes the social media server 126, the trusted device 104, the system server 124, and the financial server 128 of FIG. 1. In general, the payment module 204 of the recoup module 118 may be configured for account recoupment.

In some embodiments, to initiate an account recoupment, the payment module 204 may identify a delinquent account from the financial accounts 144. The delinquent account may include one of the financial accounts 144 discussed with reference to FIG. 1 that is held by the account holder 102 of FIG. 1. Delinquency of the account may include a failure to make a payment, a failure to make a payment during a period of time, a failure to make a series or particular number of payments, a balance owed above for a particular period, and the like. For example, the payment module 204 may identify a delinquent account when an account holder fails to make a payment in three consecutive months.

In these and other embodiments, in response to the identification of the delinquent account, the payment module 204 may communicate a solicitation message (in FIG. 3, “solicitation 302”). The solicitation message 302 may include a request for an affiliated individual 116 make a payment to the delinquent account on behalf of the account holder.

The solicitation message 302 may include a simple message explaining that an account is delinquent and a request for payment. The solicitation message 302 may include a link to a webpage or webpage information where a payment may be made.

Additionally or alternatively, the solicitation message 302 may include an event-related message such as a holiday-related message or birthday-related message. The event related message may include a request that the payment is made as a gesture related to the event. For example, on a birthday of the account holder, the solicitation message 302 may include a notification of a date of the birthday of the account holder along with a suggested gift of making a payment to the delinquent account.

The solicitation message 302 may also include an exchange with the affiliated individual 116. For example, the solicitation message 302 may include an offer to make a payment to the delinquent account in exchange for the affiliated individual 116 viewing an advertisement.

Additionally, the solicitation message 302 may include an offer to divide a payment between the delinquent account and another account held by the affiliated individual 116. For example, the solicitation message 302 may request the affiliated individual 116 to authorize a payment. The payment module 204 may apply a first portion of the payment to the delinquent account and may apply a second portion of the payment to an account held by the affiliated individual 116.

The solicitation message 302 may be communicated to the social media server 126 and/or the trusted device 104. For example, communicating the solicitation message may include sending the solicitation message 302 to a network address such as an email address or a phone number of the affiliated individual 116. Accordingly, the solicitation message may include a phone call, a text message (SMS or MMS), an email, and the like. The solicitation message 302 may be displayed on or otherwise presented to the affiliated individual 116 via a user interface of the trusted device 104.

In some embodiments, the solicitation message 302 may be transmitted to a social media account of the affiliated individual 116. For example, the solicitation message 302 may be posted in a data feed of the affiliated individual 116 or in a messaging account of the affiliated individual 116.

In response to the solicitation message 302, the affiliated individual 116 may decide to make a payment to the delinquent account on behalf of the account holder. Accordingly, the affiliated individual 116 may communicate a payment message 304 (in FIG. 3, “message 304”). The payment message 304 may be received by the payment module 204 or the system server 124. The payment message 304 may generally authorize a payment to the delinquent account.

The payment message 304 may depend on the solicitation message 302. For example, if the solicitation message 302 includes a link to a payment webpage, then the payment message 304 may include the affiliated individual 116 following a link directing the affiliated individual 116 to a payment webpage and completing a digital payment authorization form. Additionally or alternatively, if the solicitation message 302 includes a payment in exchange for viewing an advertisement, then the payment message 304 may include a selection by the affiliated individual 116 to view the advertisement. Additionally or alternatively, if the solicitation message 302 includes an event-related message, then the payment message 304 may include sending a gift to the account holder.

In embodiments in which the solicitation message 302 is communicated to the social media account of the affiliated individual 116, the payment message 304 may include communication of payment authorization information via the social media account of the affiliated individual 116.

The payment module 204 may receive the payment message 304. The payment module 204 may then apply a payment 306 to the delinquent account. In some embodiments, the payment module 204 may communicate a message to the financial server 128 to transfer the payment 306 from one of the financial accounts 144 held by the affiliated individual 116 to the delinquent account held by the account holder.

FIG. 4 illustrates an example computing device 400. The computing device 400 may be configured for account recoupment, arranged in accordance with at least one embodiment described herein. The computing device 400 may include one or more processors 404, a memory 406, a data storage 408 that includes a recoup module 412, a communication unit 402, and a user interface 414. An example of the computing device 400 may include the system server 124 discussed elsewhere herein. Accordingly, the recoup module 118 discussed elsewhere herein or some portions thereof and may be configured to perform one or more operations attributed thereto.

The processor 404 may include any suitable special-purpose or general-purpose computer, computing entity, or processing device including various computer hardware or software modules and may be configured to execute instructions stored on any applicable computer-readable storage media. For example, the processor 404 may include a microprocessor, a microcontroller, a digital signal processor (DSP), an ASIC, a FPGA, or any other digital or analog circuitry configured to interpret and/or to execute program instructions and/or to process data. Although illustrated as a single processor in FIG. 4, it is understood that the processor 404 may include any number of processors configured to perform individually or collectively any number of operations described herein. Additionally, one or more of the processors 404 may be present on one or more different electronic devices. In some embodiments, the processor 404 may interpret and/or execute program instructions and/or process data stored in the memory 406, the data storage 408, or the memory 406 and the data storage 408. In some embodiments, the processor 404 may fetch program instructions from the data storage 408 and load the program instructions in the memory 406. After the program instructions are loaded into memory 406, the processor 404 may execute the program instructions.

The memory 406 and data storage 408 may include computer-readable storage media for carrying or having computer-executable instructions or data structures stored thereon. Such computer-readable storage media may include any available media that may be accessed by a general-purpose or special-purpose computer, such as the processor 404. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may also be included within the scope of computer-readable storage media. Computer-executable instructions may include, for example, instructions and data configured to cause the processor 404 to perform a certain operation or group of operations.

The communication unit 402 may include one or more pieces of hardware configured to receive and send communications. In some embodiments, the communication unit 402 may include one or more of: an antenna, a wired port, and modulation/demodulation hardware, among other communication hardware devices. In particular, the communication unit 402 may be configured to receive a communication from outside the device 400 and to present the communication to the processor 404 for account recoupment or to send a communication from the processor 404 to another device or network.

The user interface 414 may include one or more pieces of hardware configured to notify a user of the device 400 of a communication, present a communication to a user, or to notify a user of a communication and present the communication to the user. In some embodiments, the user interface may include one or more of: a speaker, a microphone, a display, a keyboard, and a touch screen, among other hardware devices. In these and other embodiments, the user interface 414 may also be configured to receive input from a user of the device 400.

The recoup module 412 may include program instructions stored in the data storage 408. The processor 404 may be configured to load the recoup module 412 into the memory 406 and execute the recoup module 412. When executing the recoup module 412, the processor 404 may be configured to perform operations of account recoupment as described elsewhere herein.

In view of this disclosure, it will be appreciated that modifications, additions, or omissions may be made to the device 400 without departing from the scope of the present disclosure. For example, in some embodiments, the device 400 may not include the user interface 414. In some embodiments, the different components of the device 400 may be physically separate may be communicatively coupled via any suitable mechanism. For example, the data storage 408 may be part of a storage device that is separate from a server, which includes the processor 404, the memory 406, and the communication unit 402, that is communicatively coupled to the storage device.

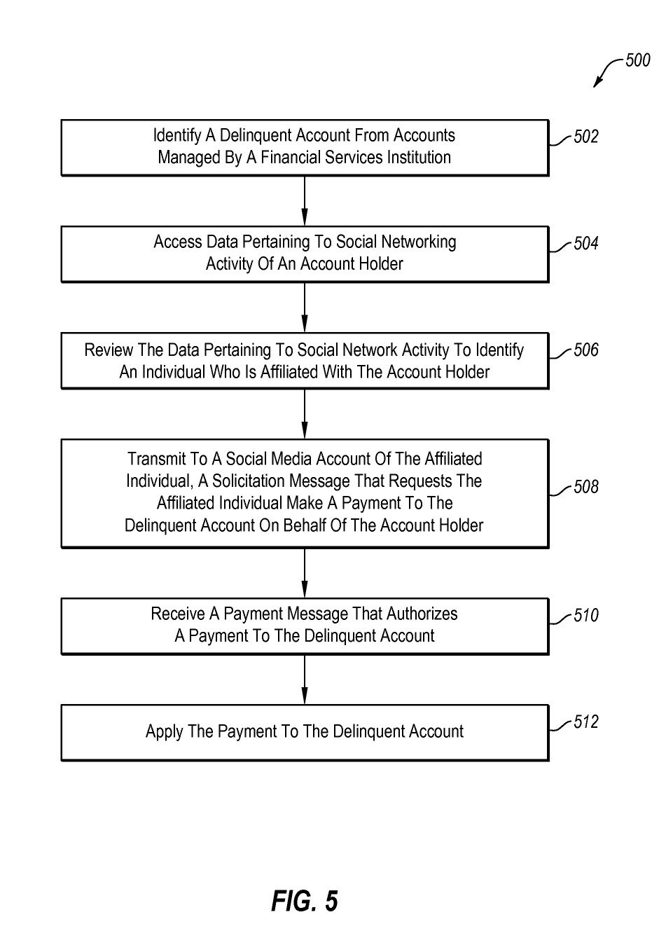

FIG. 5 is a flowchart of an example method 500 of account recoupment, which may be arranged in accordance with at least one embodiment described herein. The method 500 may be implemented, in some embodiments, by a computing device or computing system, such as the system server 124 discussed herein or the computing device 400 discussed with reference to FIG. 4. In some embodiments, the system server 124 or the computing device 400 may include or may be communicatively coupled to a non-transitory computer-readable medium (e.g., the data storage 408 or memory 406 of FIG. 4) having stored thereon programming code or instructions (e.g., the recoup module 412 of FIG. 4) that are executable by a processor (such as the processor 404 of FIG. 4) to cause the system server 124 or the computing device 400 to perform the method 500. Additionally or alternatively, the system server 124 or the computing device 400 may include the processor 404 described above that is configured to execute computer instructions to cause the system server 124 or the computing device 400 or another computing device to perform the method 500. Although illustrated as discrete blocks, various blocks may be divided into additional blocks, combined into fewer blocks, or eliminated, depending on the desired implementation.

The method 500 may begin at block 502. At block 502, a delinquent account may be identified from financial accounts managed by a financial services institution. The delinquent account may be held by an account holder. At block 504, data pertaining to social networking activity of the account holder may be accessed. The data pertaining to the social network activity may include a number of photographs or videos in which the account holder and the individual are tagged, a frequency or number of posts to a data feed of the individual by the account holder to a data feed of the account holder by the individual, a frequency or number of RSVPs to common calendar event by the account holder and the individual, a number of RSVPs to a common calendar event by the account holder and the individual, a relationship status of an individual with relation to the account holder, or some combination thereof.

At block 506, the data pertaining to social network activity may be reviewed to identify an individual who is affiliated with the account holder. At block 508, a solicitation message may be transmitted to a social media account of the affiliated individual. The solicitation message may request the affiliated individual make a payment to the delinquent account on behalf of the account holder. At block 510, a payment message may be received that authorizes a payment to the delinquent account. At block 512, the payment may be applied to the delinquent account.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments. For example, in some embodiments, the method 500 may include reading a network address linked to the delinquent account of the account holder. In these and other embodiments, a social media account of the account holder may be determined based on the network address.

In some embodiments, data pertaining to executed financial transactions may be parsed. The executed financial transactions may draw on the delinquent account. A social media account from which the executed financial transactions originated may be traced. It may be ascertained that the social media account is a social media account of the account holder.

Additionally or alternatively, the method 500 may include retrieving location data. For example, location data of the trusted device and of an account holder device associated with the account holder may be retrieved. From the location data, a device location pattern of the account holder device and a device location pattern of the trusted device may be created. It may then be determined whether an overlap of the device location pattern of the trusted device and the device location pattern of the account holder device is greater than a particular threshold.

In some embodiments, a network address of the affiliated individual may be identified. For example, the network address may be identified from data pertaining to financial transactions or a review of data pertaining to social media activity. In these and other embodiments, the solicitation message may be sent to the network address affiliated individual.

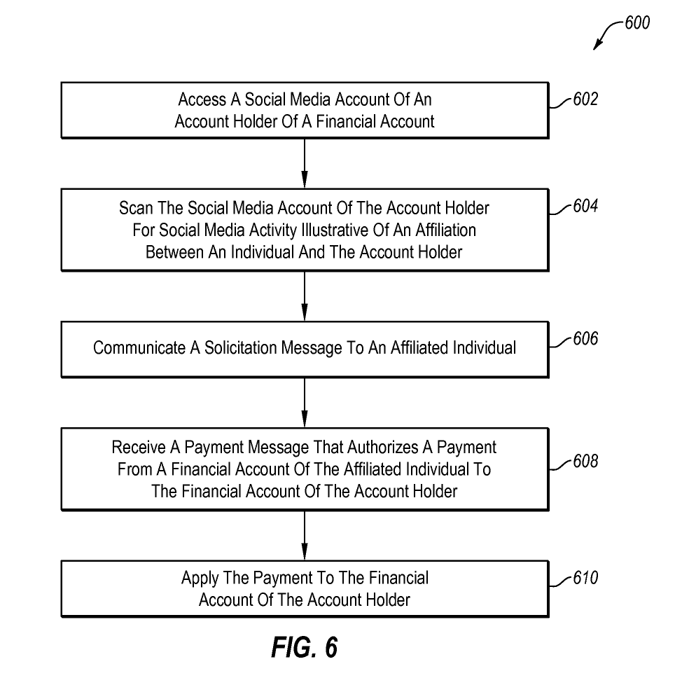

FIG. 6 is a flowchart of another example method 600 of account recoupment, which may be arranged in accordance with at least one embodiment described herein. The method 600 may be implemented, in some embodiments, by a computing device or computing system, such as the system server 124 discussed herein or the computing device 400 discussed with reference to FIG. 4. In some embodiments, the system server 124 or the computing device 400 may include or may be communicatively coupled to a non-transitory computer-readable medium (e.g., the data storage 408 or memory 406 of FIG. 4) having stored thereon programming code or instructions (e.g., the recoup module 412 of FIG. 4) that are executable by a processor (such as the processor 404 of FIG. 4) to cause the system server 124 or the computing device 400 to perform the method 600. Additionally or alternatively, the system server 124 or the computing device 400 may include the processor 404 described above that is configured to execute computer instructions to cause the system server 124 or the computing device 400 or another computing device to perform the method 600. Although illustrated as discrete blocks, various blocks may be divided into additional blocks, combined into fewer blocks, or eliminated, depending on the desired implementation.

The method 600 may begin at block 602. At block 602, a social media account of an account holder of a financial account may be accessed. In some embodiments, the social media account of the account holder may be accessed based at least partially on a network address that is included in financial account information of the financial account.

At block 604, the social media account of the account holder may be scanned for social media activity illustrative of an affiliation between an individual and the account holder. The social network activity may include photographs or videos in which the account holder and the individual are tagged, posts to a data feed of the individual and/or account holder, RSVPs to common calendar events by the account holder and the individual, and a relationship status of an individual with relation to the account holder, among other social network activity.

At block 606, a solicitation message may be communicated to an affiliated individual. The solicitation message may request the affiliated individual make a payment to the financial account of the account holder. The solicitation message may be communicated in response to the account becoming delinquent.

At block 608, a payment message that authorizes a payment from a financial account of the affiliated individual to the financial account of the account holder may be received. At block 610, the payment may be applied to the delinquent account. For example, in response to reception of the payment message, the payment may be applied to the financial account.

In some embodiments, after identifying the affiliated individual from the social media activities, the method 600 may include retrieving a network address of the affiliated individual. The network address of the affiliated individual may be compared to one or more financial accounts managed by a financial services institution. Additionally, one or more other network addresses of the affiliated individual may be retrieved from the financial account managed by the financial services institution. In these and other embodiments, communicating the solicitation message includes sending a request to the one or more other network addresses of the affiliated individual.

As indicated above, the embodiments described herein may include the use of a special purpose or general purpose computer (e.g., the processor 404 of FIG. 4) including various computer hardware or software modules, as discussed in greater detail below. Further, as indicated above, embodiments described herein may be implemented using computer-readable media (e.g., the data storage 408 or the memory 406 of FIG. 4) for carrying or having computer-executable instructions or data structures stored thereon.

As used herein, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

1. A method, comprising:
identifying, by a system server including memory and a processor, a delinquent account from a plurality of accounts managed by a financial services institution, the delinquent account being held by an account holder;
reading, by the system server, a network address of the account holder from data that is associated with an electronic payment executed by the account holder using the delinquent account;
based on the network address and other of the data that is associated with the electronic payment, determining, by the system server, a social media account of the account holder, the social media account being part of a social media system;
accessing, by the system server, a data feed of the account holder that is hosted by a social media server of the social media system;
using a requesting operation, requesting through the data feed, by the system server, data pertaining to social networking activity of the account holder in the social media account;
reviewing, by the system server, the data pertaining to social network activity to identify an individual who is affiliated with the account holder;
transmitting, by the system server, a solicitation message to a social media account of the affiliated individual that requests the affiliated individual make a payment to the delinquent account on behalf of the account holder;
receiving a payment message from the social media account of the affiliated individual that authorizes a payment to the delinquent account; and
applying, by the system server, the payment to the delinquent account.

2. (canceled)

3. The method of claim 1, further comprising:
parsing data pertaining to executed financial transactions that are drawn on the delinquent account, wherein the determining the social media account is further based on the parsed data.

4. The method of claim 1, wherein the data pertaining to the social network activity includes one or more data types selected from a group of data types including:
a number of photographs in which the account holder and the individual are tagged,
a number of videos in which the account holder and the individual are tagged,
a frequency of posts to a data feed of the individual by the account holder,
a number of posts to a data feed of the individual by the account holder,
a number of posts to the data feed of the account holder by the individual,
a frequency of posts to the data feed of the account holder by the individual,
a frequency of RSVPs to common calendar events by the account holder and the individual,
a number of RSVPs to common calendar events by the account holder and the individual, and
a relationship status of an individual with relation to the account holder.

5. The method of claim 1, further comprising identifying a network address of the affiliated individual, wherein the transmitting the solicitation message includes sending the solicitation message to the network address of the affiliated individual.

6. The method of claim 5, wherein the identifying the network address of the affiliated individual includes parsing a social media account of the affiliated individual for the network address.

7. The method of claim 6, further comprising:
retrieving location data of a trusted device and of an account holder device associated with the account holder;
creating from the location data a device location pattern of the account holder device and a device location pattern of the trusted device; and
determining whether an overlap of the device location pattern of the trusted device and the device location pattern of the account holder device is greater than a particular threshold.

8. One or more non-transitory computer-readable media storing one or more programs that are configured, in response to execution by one or more processors, to cause a system to execute or control the execution of the method as recited in claim 1.

9. A system comprising:
one or more processors; and
one or more computer-readable storage media communicatively coupled to the one or more processors and storing instructions that, in response to execution by the one or more processors, cause the one or more processors to perform operations comprising:
identifying a delinquent account from a plurality of accounts managed by a financial services institution, the delinquent account being held by an account holder;
communicating to a social media server, an application programming interface (API) call including a get subroutine that is configured to retrieve data from the social media server pertaining to social network activity of the account holder that is illustrative of an affiliation between the account holder and an individual;
receiving from the social network activity from the social media server;
reviewing the social network activity to identify an individual affiliated with the account holder;
communicating a solicitation message that requests the affiliated individual make a payment to the delinquent account on behalf of the account holder;
receiving a payment message that authorizes a payment to the delinquent account; and
applying the payment to the delinquent account.

10. The system of claim 9, wherein identifying the individuals includes one or more operations selected from a group of operations including:
downloading from an account holder device associated with the account holder, a contact list;
downloading from the account holder device, data pertaining to a communication history of the account holder;
parsing data pertaining to financial transactions of the account holder;
communicating to a social media server, an API call including a get subroutine that is configured to obtain location data of a device associated with the individual; and
creating a pattern of device location data of a device associated with the individual.

11. The system of claim 10, wherein the data pertaining to the communication history includes one or more data types selected from a group of data types including:
a number of telephone calls, emails, text messages, and media communications between an individual and the account holder; and
a frequency of telephone calls, emails, text messages, and media communications between an individual and the account holder.

12. The system of claim 9, wherein the operations further comprise requesting identification of an affiliated individual from the account holder during execution of a financial transaction with the financial services institution.

13. The system of claim 12, wherein requesting identification occurs in response to the financial transaction including one or more transactional characteristics from a group of transactional characteristics including:
an extension of credit by the financial services institution for execution of the financial transaction;
a monetary amount involved in the financial transaction; and
a payment history of the account holder.

14. The system of claim 9, wherein the payment message includes one or more payment messages from a group of message types including:
payment authorization information communicated via a social media account of the affiliated individual;
viewing an advertisement;
a transaction involving the affiliated individual and the financial services institution; and
sending a gift to the account holder.

15. The system of claim 9, wherein the solicitation message includes one or more solicitation messages from a group of solicitation message types including:
an event-related message;
an exchange with the affiliated individual for viewing an advertisement; and
an offer to divide a payment between the delinquent account and another account held by the affiliated individual.

16. A method, comprising:
reading, by a system server including memory and a processor, a network address of a account holder from data that is associated with an electronic payment executed by the account holder using a financial account;
based on the network address and other the data that is associated with the electronic payment, determining, by the system server, a social media account of the account holder;
accessing, by the system server, the social media account of an account holder of the financial account;
scanning, by the system server, the social media account of the account holder for social media activity illustrative of an affiliation between an individual and the account holder;
in response to the financial account becoming delinquent, communicating, by the system server, a solicitation message to the affiliated individual, the solicitation message requesting the affiliated individual make a payment to the financial account of the account holder;
receiving, by the system server, a payment message that authorizes a payment from a financial account of the affiliated individual to the financial account of the account holder; and
in response to reception of the payment message, applying, by the system server, the payment to the financial account of the account holder.

17. The method of claim 16, further comprising:
after identifying the affiliated individual from the social media activities, retrieving a network address of the affiliated individual;
comparing the network address of the affiliated individual to one or more financial accounts managed by a financial services institution; and
from the financial account managed by the financial services institution, reading one or more other network addresses of the affiliated individual.

18. The method of claim 17, wherein the communicating the solicitation message includes sending a request to the one or more other network addresses of the affiliated individual.

19. (canceled)

20. One or more non-transitory computer-readable media storing one or more programs that are configured, in response to execution by one or more processors, to cause a system to execute or control the execution of the method as recited in claim 16.

21. The method of claim 1, further comprising requesting identification of an affiliated individual from the account holder during execution of a financial transaction with the financial services institution.

22. The method of claim 1, wherein the solicitation message includes one or more solicitation messages from a group of solicitation message types including:
an event-related message;
an exchange with the affiliated individual for viewing an advertisement; and
an offer to divide a payment between the delinquent account and another account held by the affiliated individual.
